(19) United States
(12) Patent Application Publication
(10) Pub. No.: US 2024/0413894 A1
(43) Pub. Date: Dec. 12, 2024

(54) STACKING ARRANGEMENT FOR SPACE VEHICLES

(71) Applicant: NETWORK ACCESS ASSOCIATES LIMITED, London (GB)

(72) Inventors: Dominique PONCET, London (GB); Manraj NAGI, London (GB)

(21) Appl. No.: 18/812,015

(22) Filed: Aug. 22, 2024

Related U.S. Application Data
(63) Continuation of application No. PCT/IB2023/000090, filed on Feb. 24, 2023.

(30) Foreign Application Priority Data
Feb. 25, 2022 (FR) 2201669

(51) Int. Cl. H04B 7/185

(52) U.S. Cl. CPC H04B 7/18521; H04B 7/18539

(57) ABSTRACT

A system having a layer of satellites including first, second, third, and fourth satellites, each having left and right sides; a first interface element connected to the left side of the first satellite; a second interface element connected to the right side of the first satellite; a third interface element connected to the left side of the second satellite and the second interface element; a fourth interface element connected to the right side of the second satellite; a fifth interface element connected to the left side of the third satellite and the fourth interface element; a sixth interface element connected to right side of the third satellite; a seventh interface element connected to the left side of the fourth satellite and the sixth interface element; and an eighth interface element connected to the right side of the fourth satellite and the first interface element, thereby forming the layer of satellites.

### FIELD OF THE INVENTION

The field of the invention relates to space vehicles, and, more particularly, to arrangements for stacking space vehicles on launch vehicles.

### BACKGROUND OF THE INVENTION

Conventionally-built satellites utilize sandwich panels having honeycomb cores (made from aluminium (aluminum), phenolic paper, or composites, for example) to construct load-bearing structures. When such satellites are stacked on a launch vehicle, challenges often arise in maintaining the stability of the stack during launch, such as in reaching a minimum lateral frequency that is acceptable for the stack during launch.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a stack of space vehicles including a plurality of space vehicles, wherein each of the plurality of space vehicles includes a first stacking pillar, a second stacking pillar, and a stiffener connecting the first stacking pillar and the second stacking pillar; wherein the stacking pillars of adjacent ones of the space vehicles form a mechanical connection between the stiffeners of the respective space vehicles to thereby cause the stack to behave as a single connected structure.

In some embodiments, the present invention provides a system, comprising: a first layer of satellites, wherein the first layer of satellites comprises a first satellite, a second satellite, a third satellite, and a fourth satellite, and wherein each of the first, second, third, and fourth satellites comprises: a top side, a bottom side opposite the top side, a zenith facing side extending between the top and bottom sides, wherein the zenith facing side is configured to face away from the earth when the satellite is in orbit, an earth facing side opposite the zenith facing side and extending between the top and bottom sides, wherein the earth facing side is configured to face the earth when the satellite is in orbit, a left side extending between the top and bottom sides, and a right side opposite the left side and extending between the top and bottom sides; a first interface element connected to the first satellite, proximate the left side of the first satellite; a second interface element connected to the first satellite, proximate the right side of the first satellite; a third interface element connected to the second satellite, proximate the left side of the second satellite; a fourth interface element connected to the second satellite, proximate the right side of the second satellite; a fifth interface element connected to the third satellite, proximate the left side of the third satellite; a sixth interface element connected to the third satellite, proximate the right side of the third satellite; a seventh interface element connected to the fourth satellite, proximate the left side of the fourth satellite; and an eighth interface element connected to the fourth satellite, proximate the right side of the fourth satellite, wherein the first interface element connects to the eighth interface element, wherein the second interface element connects to the third interface element, wherein the fourth interface element connects to the fifth interface element, and wherein the sixth interface element connects to the seventh interface element, to prevent the first, second, third, and fourth satellites from moving apart from one another, thereby forming the first layer of satellites.

In some embodiments, the system further comprises a second layer of satellites, wherein the second layer of satellites comprise a fifth satellite, a sixth satellite, a seventh satellite, and an eighth satellite, wherein each of the fifth, sixth, seventh, and eighth satellites comprises: a top side, a bottom side opposite the top side, a zenith facing side extending between the top and bottom sides, an earth facing side opposite the zenith facing side and extending between the top and bottom sides, a left side extending between the top and bottom sides, and a right side opposite the left side and extending between the top and bottom sides; a ninth interface element connected to the fifth satellite, proximate the left side of the fifth satellite; a tenth interface element connected to the fifth satellite, proximate the right side of the fifth satellite; an eleventh interface element connected to the sixth satellite, proximate the left side of the sixth satellite; a twelfth interface element connected to the sixth satellite, proximate the right side of the sixth satellite; a thirteenth interface element connected to the seventh satellite, proximate the left side of the seventh satellite; a fourteenth interface element connected to the seventh satellite, proximate the right side of the seventh satellite; a fifteenth interface element connected to the eighth satellite, proximate the left side of the eighth satellite; and a sixteenth interface element connected to the eighth satellite, proximate the right side of the eighth satellite, wherein the ninth interface element connects to the sixteenth interface element, wherein the tenth interface element connects to the eleventh interface element, wherein the twelfth interface element connects to the thirteenth interface element, and wherein the fourteenth interface element connects to the fifteenth interface element, to prevent the fifth, sixth, seventh, and eighth satellites from moving apart from one another, thereby forming the second layer of satellites.

In some embodiments, the second interface element comprises a second contact surface, the third interface element comprises a third contact surface, and the second and third contact surfaces are in contact with one another.

In some embodiments, the second interface element comprise a second body portion and a second contacting portion, the second contacting portion extends from the second body portion and comprises the second contact surface, the third interface element comprise a third body portion and a third contacting portion, and the third contacting portion extends from the third body portion and comprises the third contact surface.

In some embodiments, each of the second and third contact surfaces comprises a flat surface.

In some embodiments, each of the second and third contact surfaces comprises a curved surface.

In some embodiments, each of the second and third contact surfaces comprises a surface having a convex portion and a concave portion.

In some embodiments, the first satellite further comprises a first pillar at the left side of the first satellite, wherein the first interface element is at least partially within the first pillar, and the first satellite further comprises a second pillar at the right side of the first satellite, wherein the second interface element is at least partially within the second pillar.

In some embodiments, the second interface element comprise a second body portion and a second contacting portion, wherein the second contacting portion extends from the second body portion and comprises the second contact surface.

In some embodiments, the first satellite further comprises: a stiffener within an interior of the first satellite, wherein the stiffener extends between the left and right sides of the first satellite.

In some embodiments, the first and second interface elements are connected to the stiffener.

In some embodiments, the first satellite further comprises: a first pillar at the left side of the first satellite, wherein first interface element is at least partially within the first pillar; and a second pillar at the right side of the first satellite, wherein the second interface element is at least partially within the second pillar, and wherein the first and second pillars connect to the stiffener.

In some embodiments, the system further comprises a second layer of satellites above the first layer of satellites, wherein the second layer comprises four additional satellites.

In some embodiments, the system further comprises seven additional layers of satellites above the first layer of satellites, wherein each of the additional layers of satellites comprises four additional satellites.

In some embodiments, the present invention provides a system, comprising: a first layer of satellites, wherein the first layer of satellites comprises a first satellite, a second satellite, a third satellite, a fourth satellite, a fifth satellite, and a sixth satellite, and wherein each of the first, second, third, fourth, fifth, and sixth satellites comprises: a top side, a bottom side opposite the top side, a zenith facing side extending between the top and bottom sides, an earth facing side opposite the zenith facing side and extending between the top and bottom sides, a left side extending between the top and bottom sides, and a right side opposite the left side and extending between the top and bottom sides; a first interface element connected to the first satellite, proximate the left side of the first satellite; a second interface element connected to the first satellite, proximate the right side of the first satellite; a third interface element connected to the second satellite, proximate the left side of the second satellite; a fourth interface element connected to the second satellite, proximate the right side of the second satellite; a fifth interface element connected to the third satellite, proximate the left side of the third satellite; a sixth interface element connected to the third satellite, proximate the right side of the third satellite; a seventh interface element connected to the fourth satellite, proximate the left side of the fourth satellite; an eighth interface element connected to the fourth satellite, proximate the right side of the fourth satellite; a ninth interface element connected to the fifth satellite, proximate the left side of the fifth satellite; an tenth interface element connected to the fifth satellite, proximate the right side of the fifth satellite; an eleventh interface element connected to the sixth satellite, proximate the left side of the sixth satellite; and a twelfth interface element connected to the sixth satellite, proximate the right side of the sixth satellite; wherein the first interface element connects to the twelfth interface element, wherein the second interface element connects to the third interface element, wherein the fourth interface element connects to the fifth interface element, wherein the sixth interface element connects to the seventh interface element, wherein the eighth interface element connects to the ninth interface element, and wherein the tenth interface element connects to the eleventh interface element, to prevent the first, second, third, fourth, fifth, and sixth satellites from moving apart from one another, thereby forming the first layer of satellites.

In some embodiments, the second interface element comprises a second contact surface, the third interface element comprises a third contact surface, and the second and third contact surfaces are in contact with one another.

In some embodiments, the second interface element comprise a second body portion and a second contacting portion, the second contacting portion extends from the second body portion and comprises the second contact surface, the third interface element comprise a third body portion and a third contacting portion, and the third contacting portion extends from the third body portion and comprises the third contact surface.

In some embodiments, the first satellite further comprises: a stiffener within an interior of the first satellite, and the stiffener extends between the left and right sides of the first satellite.

In some embodiments, the first and second interface elements are connected to the stiffener.

In some embodiments, the first satellite further comprises: a first pillar at the left side of the first satellite, wherein first interface element is at least partially within the first pillar; and a second pillar at the right side of the first satellite, wherein the second interface element is at least partially within the second pillar, and wherein the first and second pillars connect to the stiffener.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 shows a perspective view of a space vehicle, in accordance with some embodiments of the invention.

FIG. 2 shows a perspective view of a space vehicle, in accordance with some embodiments of the invention.

FIG. 3 shows a perspective view of components of a space vehicle, in accordance with some embodiments of the invention.

FIG. 4 shows cross-sectional views of embodiments of a stiffener of a space vehicle, in accordance with some embodiments of the invention.

FIG. 5 shows dimensions of a space vehicle, in accordance with some embodiments of the invention.

FIG. 6A shows an arrangement of multiple space vehicles in a layer, in accordance with some embodiments of the invention.

FIG. 6B shows an arrangement of multiple space vehicles in a layer, in accordance with some embodiments of the invention.

FIG. 7 shows an arrangement of multiple space vehicles in a layer, in accordance with some embodiments of the invention.

FIG. 8A shows a representation of multiple space vehicles in a layer, in accordance with some embodiments of the invention.

FIG. 8B shows a representation of multiple space vehicles in a layer, in accordance with some embodiments of the invention.

FIG. 9A shows a perspective view of a shear interface element, in accordance with some embodiments of the invention.

FIG. 9B shows an interface of two of the shear interface elements of FIG. 9A, in accordance with some embodiments of the invention.

FIG. 10A shows a perspective view of a shear interface element, in accordance with some embodiments of the invention.

FIG. 10B shows an interface of two of the shear interface elements of FIG. 10A, in accordance with some embodiments of the invention.

FIG. 10C shows a layer of space vehicles including multiple shear interface elements of FIG. 10A, in accordance with some embodiments of the invention.

FIG. 11 shows a perspective view of a stack of space vehicles, in accordance with some embodiments of the invention.

FIG. 12 shows a perspective view of space vehicle including additional pillars, in accordance with some embodiments of the invention.

### DETAILED DESCRIPTION

In addition to the benefits and improvements that the Specification discloses, other objects and advantages of that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

The embodiments described herein relate to space vehicles, such as but not limited to satellites. The embodiments described herein also relate to methods for manufacture of the space vehicles.

In some embodiments, the present invention is directed to a system, comprising a first layer of satellites. In some embodiments, the first layer of satellites comprises a first satellite, a second satellite, a third satellite, and a fourth satellite (that is, four satellites). In some embodiments, the first layer of satellites comprises a first satellite, a second satellite, a third satellite, a fourth satellite, a fifth satellite, and a sixth satellite (that is, six satellites). In some embodiments, the present invention is directed to a layer of less than four satellites. In some embodiments, the present invention is directed to a layer of more than four satellites. In some embodiments, the present invention is directed to a layer of less than six satellites. In some embodiments, the present invention is directed to a layer of more than six satellites. In some embodiments, the layer of satellites includes one, two, three, four, five, six, seven, eight, nine, ten, or more than ten satellites.

In some embodiments, one or more, or all, of the satellites in the layer comprise a top side, and a bottom side opposite the top side. In some embodiments, the satellites comprise a zenith facing side extending between the top and bottom sides, wherein the zenith facing side is configured to face away from the earth when the satellite is in orbit. In some embodiments, the satellites comprise an earth facing side opposite the zenith facing side and extending between the top and bottom sides, wherein the earth facing side is configured to face the earth when the satellite is in orbit. In some embodiments, the satellites comprise a left side extending between the top and bottom sides, and a right side opposite the left side and extending between the top and bottom sides.

In some embodiments, one or more interface elements connect to the satellites. In some embodiments, when the layer of satellites includes four satellites, for example, the system comprises a first interface element connected to the first satellite, proximate the left side of the first satellite; a second interface element connected to the first satellite, proximate the right side of the first satellite; a third interface element connected to the second satellite, proximate the left side of the second satellite; a fourth interface element connected to the second satellite, proximate the right side of the second satellite; a fifth interface element connected to the third satellite, proximate the left side of the third satellite; a sixth interface element connected to the third satellite, proximate the right side of the third satellite; a seventh interface element connected to the fourth satellite, proximate the left side of the fourth satellite; and an eighth interface element connected to the fourth satellite, proximate the right side of the fourth satellite, wherein the first interface element connects to the eighth interface element, wherein the second interface element connects to the third interface element, wherein the fourth interface element connects to the fifth interface element, and wherein the sixth interface element connects to the seventh interface element, to prevent the first, second, third, and fourth satellites from moving apart from one another, thereby forming the first layer of satellites.

In some embodiments, when the layer of satellites includes six satellites, for example, the system comprises a first interface element connected to the first satellite, proximate the left side of the first satellite; a second interface element connected to the first satellite, proximate the right side of the first satellite; a third interface element connected to the second satellite, proximate the left side of the second satellite; a fourth interface element connected to the second satellite, proximate the right side of the second satellite; a fifth interface element connected to the third satellite, proximate the left side of the third satellite; a sixth interface element connected to the third satellite, proximate the right side of the third satellite; a seventh interface element connected to the fourth satellite, proximate the left side of the fourth satellite; an eighth interface element connected to the fourth satellite, proximate the right side of the fourth satellite; a ninth interface element connected to the fifth satellite, proximate the left side of the fifth satellite; an tenth interface element connected to the fifth satellite, proximate the right side of the fifth satellite; an eleventh interface element connected to the sixth satellite, proximate the left side of the sixth satellite; and a twelfth interface element connected to the sixth satellite, proximate the right side of the sixth satellite; wherein the first interface element connects to the twelfth interface element, wherein the second interface element connects to the third interface element, wherein the fourth interface element connects to the fifth interface element, wherein the sixth interface element connects to the seventh interface element, wherein the eighth interface element connects to the ninth interface element, and wherein the tenth interface element connects to the eleventh interface element, to prevent the first, second, third, fourth, fifth, and sixth satellites from moving apart from one another, thereby forming the first layer of satellites. Thus, in some embodiments, regardless of the number of satellites in a layer, each of the satellites includes two interface elements, such as one on each of the left and right sides of the satellite.

In some embodiments, the system further comprises a second layer of satellites (that is, one additional layer of satellites). In some embodiments, the second layer of satellites is above or below the first layer. In some embodiments, the system includes more than one additional layer of satellites. In some embodiments, the system includes one, two, three, four, five, six, seven, eight, nine, ten, or more than ten additional layers of satellites.

In some embodiments, such as when the first layer includes four satellites, the second layer of satellites comprise a fifth satellite, a sixth satellite, a seventh satellite, and an eighth satellite, wherein each of the fifth, sixth, seventh, and eighth satellites comprises: a top side, a bottom side opposite the top side, a zenith facing side extending between the top and bottom sides, an earth facing side opposite the zenith facing side and extending between the top and bottom sides, a left side extending between the top and bottom sides, and a right side opposite the left side and extending between the top and bottom sides; a ninth interface element connected to the fifth satellite, proximate the left side of the fifth satellite; a tenth interface element connected to the fifth satellite, proximate the right side of the fifth satellite; an eleventh interface element connected to the sixth satellite, proximate the left side of the sixth satellite; a twelfth interface element connected to the sixth satellite, proximate the right side of the sixth satellite; a thirteenth interface element connected to the seventh satellite, proximate the left side of the seventh satellite; a fourteenth interface element connected to the seventh satellite, proximate the right side of the seventh satellite; a fifteenth interface element connected to the eighth satellite, proximate the left side of the eighth satellite; and a sixteenth interface element connected to the eighth satellite, proximate the right side of the eighth satellite, wherein the ninth interface element connects to the sixteenth interface element, wherein the tenth interface element connects to the eleventh interface element, wherein the twelfth interface element connects to the thirteenth interface element, and wherein the fourteenth interface element connects to the fifteenth interface element, to prevent the fifth, sixth, seventh, and eighth satellites from moving apart from one another, thereby forming the second layer of satellites.

In some embodiments, one or more, or all, of the interface elements comprise a contact surface. In some embodiments, the contact surface of one interface element is in contact with the contact surface of another interface element.

In some embodiments, one or more, or all, of the interface elements comprise a body portion and a contacting portion, wherein the contacting portion extends from the body portion and comprises the contact surface of that interface element.

In some embodiments, one or more, or all, of the contact surfaces comprise a flat surface.

In some embodiments, one or more, or all, of the contact surfaces comprise a curved surface.

In some embodiments, one or more, or all, of the contact surfaces comprise a surface having a convex portion and a concave portion.

In some embodiments, one or more, or all, of the satellites comprise one pillar at the left side of the satellite, wherein an interface element is at least partially within the pillar; and another pillar at the right side of the satellite, wherein another interface element is at least partially within the another pillar.

In some embodiments, one or more, or all, of the satellites further comprise a stiffener within an interior of the first satellite. In some embodiments, the stiffener extends between the left and right sides of the first satellite. In some embodiments, one or more interface elements are connected to the stiffener. In some embodiments, when the satellite comprises two pillars, the pillars are connected to the stiffener, and an interface element is at least partially within each of the pillars.

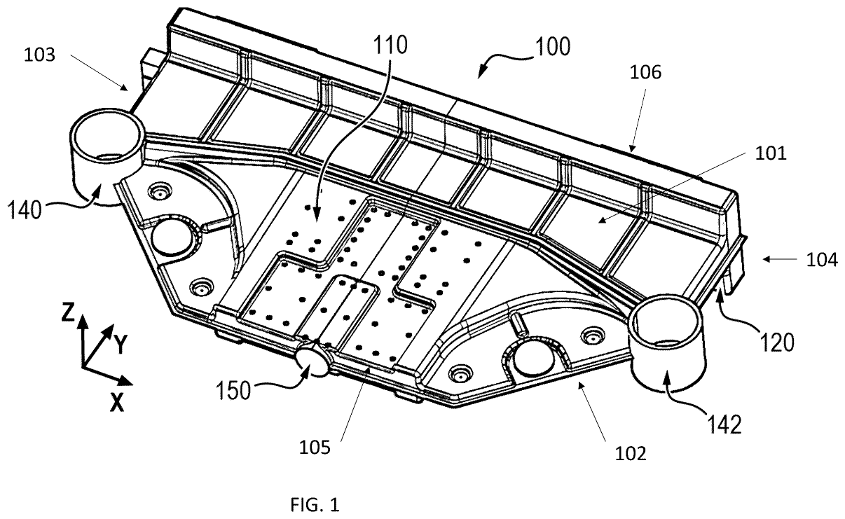

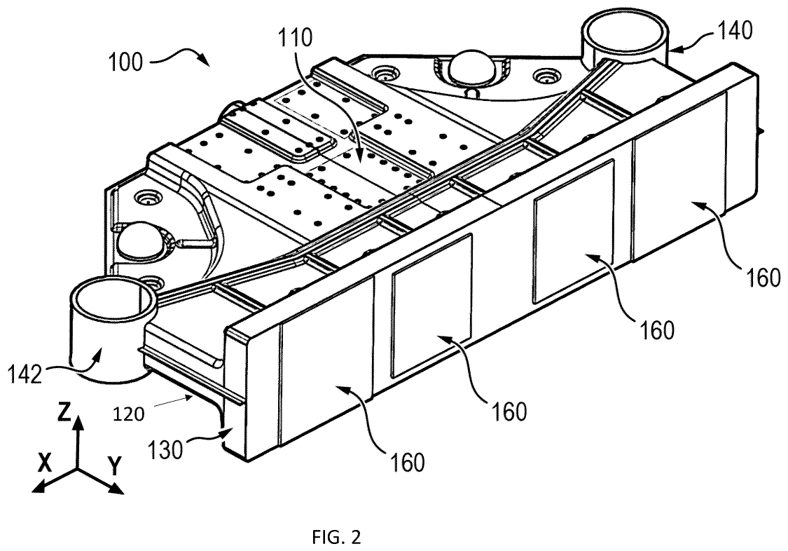

FIGS. 1 and 2 show perspective views of opposite sides of a space vehicle 100, in the form of a satellite, in accordance with some embodiments of the invention. Although the figures show the space vehicle 100 as a satellite, it is understood that the disclosure is applicable to space vehicles other than satellites. In some embodiments, the space vehicle 100 includes two panels 110, 120 forming an outer shell of the space vehicle 100. In some embodiments, the panels 110, 120 comprise a metal. In some embodiments, the panels 110, 120 comprise a metal alloy. In some embodiments, the metal alloy comprises at least one of an aluminum alloy, a steel alloy, and/or combinations thereof. In some embodiments, the metal alloy comprises an alloy other than steel and/or aluminum. In some embodiments, the panels 110, 120 comprise a composite. In some embodiments, the panels 110, 120 comprise a fiber composite. In some embodiments, the fiber composite comprises at least one of a carbon fiber composite and/or a glass fiber composite. In some embodiments, the panels 110, 120 may be formed by a stamping process. In some embodiments, the panels 110, 120 may be formed by a material-removal process. In some embodiments, the panels 110, 120 may be formed by a molding process. In some embodiments, the panels 110, 120 may be formed by an injection process. In some embodiments, the panels 110, 120 may be formed by a 3-D printing process.

In some embodiments, the panels 110, 120 are joined to one another around the perimeters of the panels 110, 120. In some embodiments, the entire perimeters of the panels 110, 120 are joined to one, thereby to form an enclosed structure. In some embodiments, less than the entire perimeters of the panels 110, 120 are joined to one. In some embodiments, the panels 110, 120 are welded to one another. In some embodiments, the panels 110, 120 are adhered to one another. In some embodiments, the panels 110, 120 are connected to one another by another process.

As shown in the figures, in some embodiments, the space vehicle 100 includes stacking pillars 140 and 142, discussed in further detail below. In some embodiments, the space vehicle 100 includes a solar array mounting interface 150. In some embodiments, the space vehicle 100 includes one or more antenna modules 160 (e.g., one or more transmitting antenna modules, receiving antenna modules, and/or transmitting and receiving antenna modules).

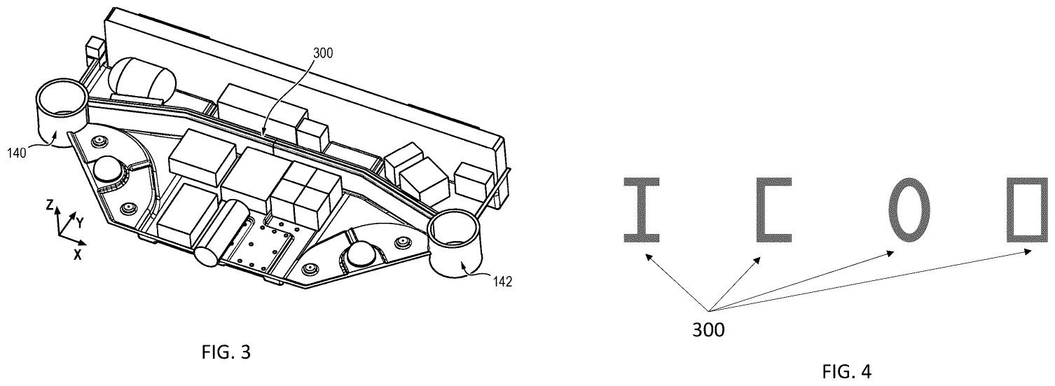

Also as shown in the figures, in some embodiments, the space vehicle 100 includes a stiffener 300. In some embodiments, the stiffener 300 may have a closed cross-section. In some embodiments, the stiffener 300 may have an open cross-section. In some embodiments, the stiffener 300 may have a square cross-section. In some embodiments, the stiffener 300 may have a circular cross-section. In some embodiments, the stiffener 300 may have an elliptical cross-section. In some embodiments, the stiffener 300 may have a T-shaped cross-section. In some embodiments, the stiffener 300 may have an I-shaped cross-section. In some embodiments, the stiffener 300 may have a C-shaped cross-section. In some embodiments, the stiffener 300 extends spanwise across an interior of the space vehicle 100. In some embodiments, the stiffener 300 extends spanwise and is located on an exterior of the space vehicle 100. FIG. 3 shows a perspective view of the space vehicle 100, with the panel 110 removed to show interior elements of the space vehicle 100. FIG. 4 shows cross-sectional views of different embodiments of the stiffener 300, in accordance with some embodiments of the invention. In some embodiments, the stiffener 300 comprises a metal. In some embodiments, the metal comprises aluminum. In some embodiments, the metal comprises steel. In some embodiments, the stiffener 300 comprises carbon. In some embodiments, the stiffener 300 comprises carbon fiber. In some embodiments, the stiffener 300 comprises carbon polymer. In some embodiments, the stiffener 300 comprises a carbon fiber reinforced polymer (“CFRP”). In some embodiments, the stiffener 300 comprises combinations of one or more of the foregoing materials.

In some embodiments, the stiffener 300 connects to the panel 110 and/or the panel 120, proximate to the stacking pillars 140, 142. In some embodiments, the stiffener 300 connects directly to the stacking pillars 140, 142. In some embodiments, the stiffener 300 provides a mechanical connection between the stacking pillars 140, 142. In some embodiments, the stacking pillars 140, 142 are connected directly to the stiffener 300. In some embodiments, the stacking pillars 140, 142 are connected to another structure of the space vehicle 100.

In some embodiments, each of the stacking pillars 140, 142 includes a locking mechanism operable to releasably lock the respective one of the stacking pillars 140, 142 to stacking pillars of an adjacent space vehicle within a stack of space vehicles and/or within a layer of space vehicles, through the use of interface elements, as further described below. In some embodiments, the locking mechanism comprises an internal locking mechanism.

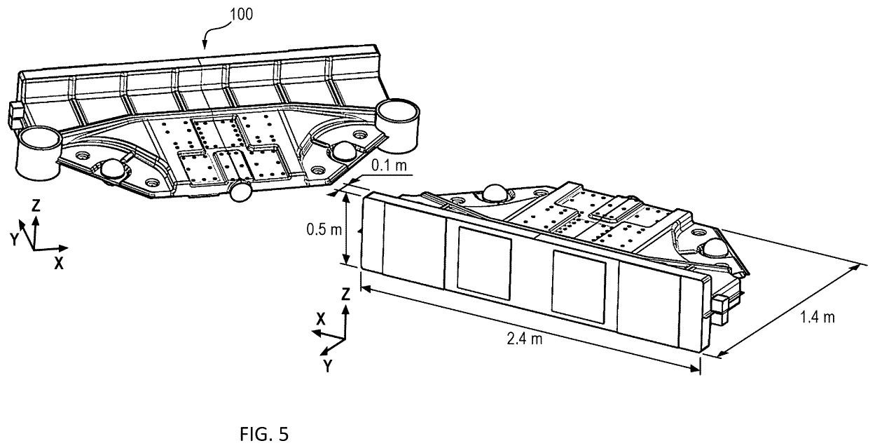

In some embodiments, the space vehicle 100 that is shaped as shown in FIGS. 1 and 2, and which has stacking pillars 140, 142 positioned as shown in FIGS. 1 and 2, is suitable for stacking, for example, either four of the space vehicles 100 or six of the space vehicles 100 in a single layer on a launch vehicle. As discussed in detail below, in some embodiments, the space vehicle 100 is appropriately sized and shaped to allow placement of four of the space vehicles 100 in a single layer of a launch stack that fits within a circle 4.5 meters in diameter, such as within the fairing of a rocket or other launch vehicle which has a diameter of 5 meters. Also as discussed in further detail below, in some embodiments, the space vehicle 100 is also appropriately sized and shaped to allow placement of six of the space vehicles 100 in a single layer of a launch stack that fits within a circle 6.35 meters in diameter. In some embodiments, such sizing and placement are suitable for use on a launch vehicle or rocket having a fairing which has a diameter of 7 meters. FIG. 5 shows the space vehicle 100 that is sized for stacking of four of the space vehicles 100 or six of the space vehicles 100 as described above. It will be apparent to those of skill in the art, however, that the sizing shown in FIG. 5 is only exemplary, and that a space vehicle in accordance with the exemplary embodiments disclosed herein may also have any other dimensions, and that a layer of space vehicles may have one, two, three, four, five, six, seven, eight, nine, ten, or more than ten space vehicles in the layer.

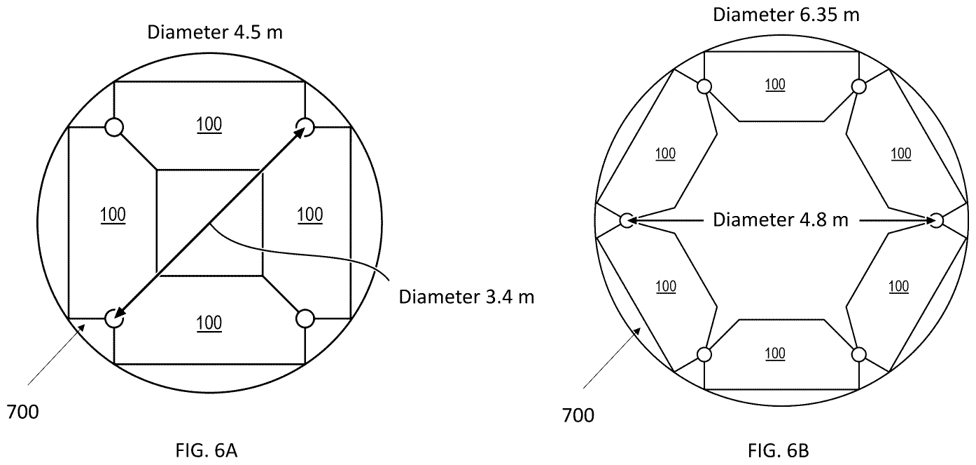

FIG. 6A shows four of the space vehicles 100 sized as shown in FIG. 5, arranged in a single layer that fits within a circle that is 4.5 meters in diameter. FIG. 6B shows six of the space vehicles 100 sized as shown in FIG. 5 and arranged in a single layer that fits within a circle 6.35 meters in diameter. It may be seen from FIGS. 6A and 6B that the stacking pillars 140, 142 of the space vehicle 100 are appropriately positioned for use in either the layer of four of the space vehicles 100 as shown in FIG. 6A or the layer of six of the space vehicle 100 shown in FIG. 6B.

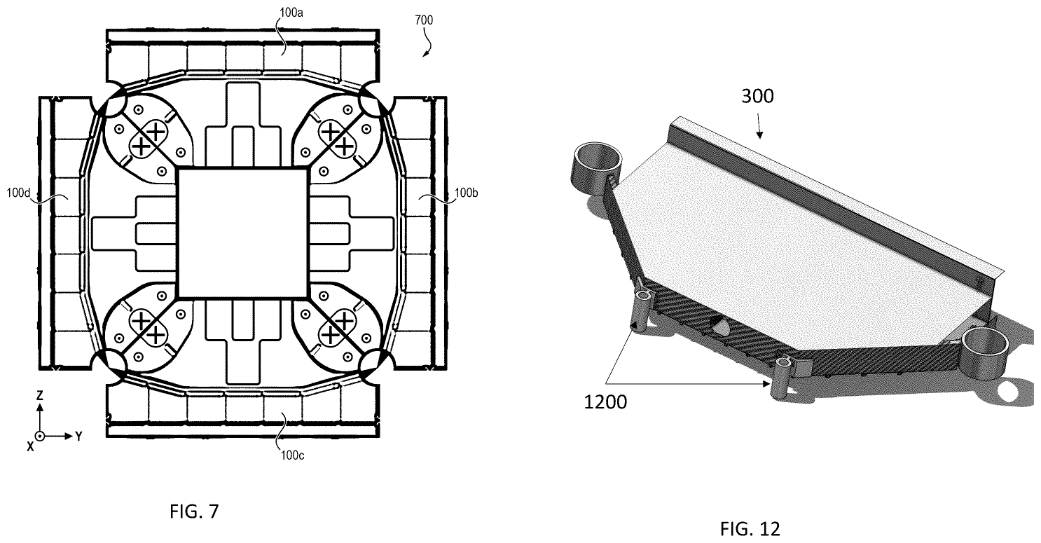

In some embodiments, a layer including several (e.g., two, three, four, five, six, seven, eight, nine, ten, or more than ten) of the space vehicles 100 that are linked to one another at the respective stacking pillars 140, 142 form a connected structure through the connections between the stacking pillars 140, 142 and the stiffeners 300. FIG. 7 shows an exemplary layer 700 showing such interconnection between space vehicles 100a, 100b, 100c, and 100d. As discussed, the system may include multiple layers of space vehicles.

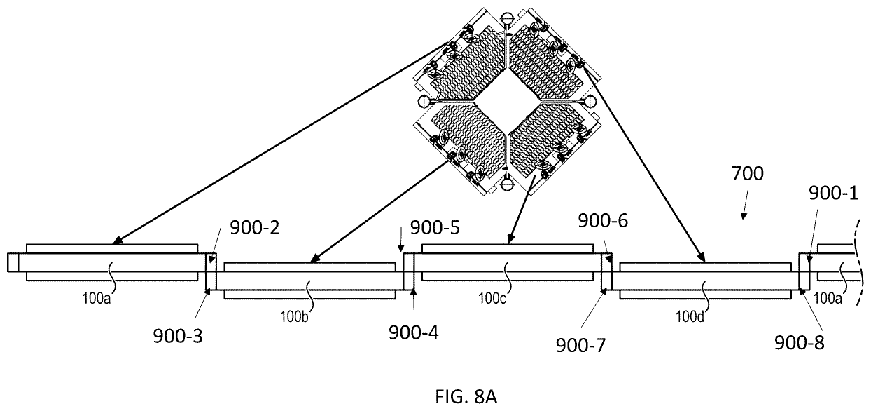

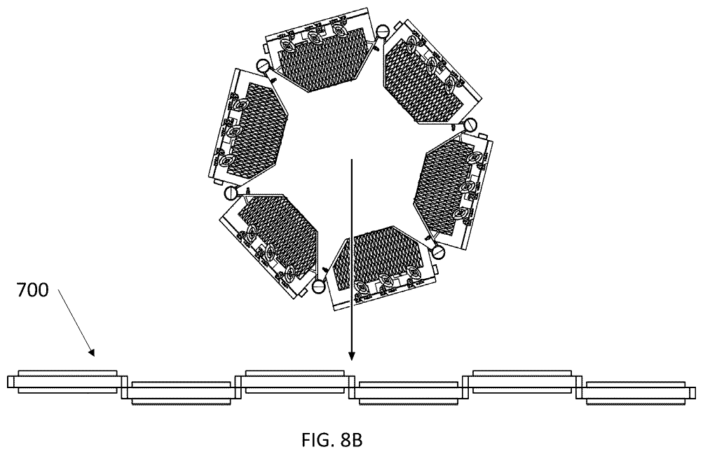

In some embodiments, the vertical positions of the space vehicles 100 within a given layer are staggered. For example, in some embodiments, the space vehicles 100a and 100c in FIG. 7 are positioned half a layer above the space vehicles 100b and 100d in FIG. 7, in order for the stacking pillars 140, 142 of the space vehicles 100a and 100c to engage the stacking pillars 140, 142 of the space vehicles 100b and 100d. FIG. 8A shows the layer 700 previously shown in FIG. 7, in an “unwound” or “opened” manner to represent the connections between the respective stacking pillars 140, 142 of the space vehicles 100a, 100b, 100c, and 100d, in accordance with some embodiments of the invention. FIG. 8B shows a similarly “unwound” or “opened” representation of a similar layer including six of the space vehicles 100, in accordance with some embodiments of the invention.

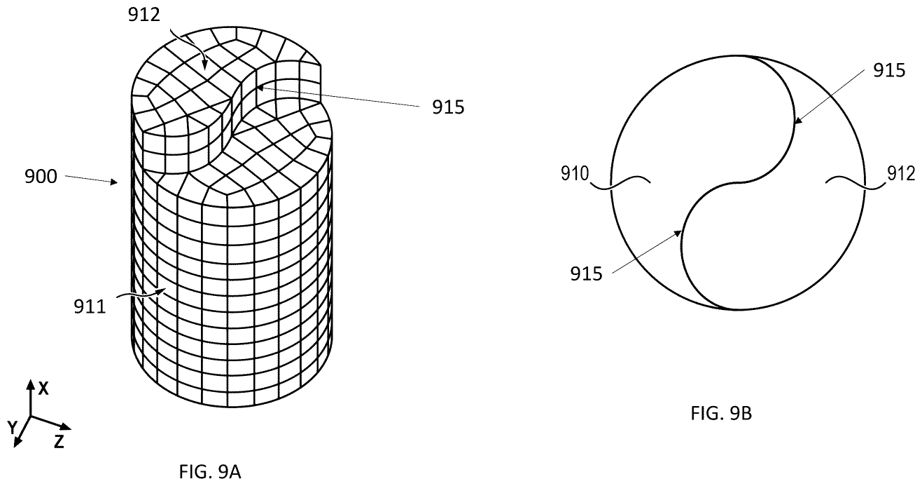

In some embodiments, the stacking pillars 140, 142 of the space vehicle 100 include internal elements that are configured (e.g., sized, shaped, and/or oriented) to bear on one another, so as to bear shear loads within a layer including multiple space vehicle 100. FIG. 9A shows a perspective view of an embodiment of a shear interface element 900, in accordance with some embodiments of the invention. FIG. 9B shows an interface of two of the shear interface elements 900. It may be seen that the shear interface elements 900 abut one another in a manner so as to bear shear loads in either the horizontal direction or the vertical direction, as described with reference to the viewpoint of FIG. 9B. The shear interface elements may include a body portion 911, and a contacting portion 912 that extends from the body portion 911. As shown, the shear interface elements 900 may include contact surfaces 915 on the contacting portions 912, in the form of complementary curved surfaces, each of which has a concave and a convex portion, which are configured to contact one another. The shear interface elements 900 may be shaped such that when the contact surfaces 915 of the shear interface elements 900 contact each other, the shear interface elements 900 define a circular cross-section. The shear interface elements 900 may be shaped so that the shear interface elements 900 meet one another in a “yin yang” manner.

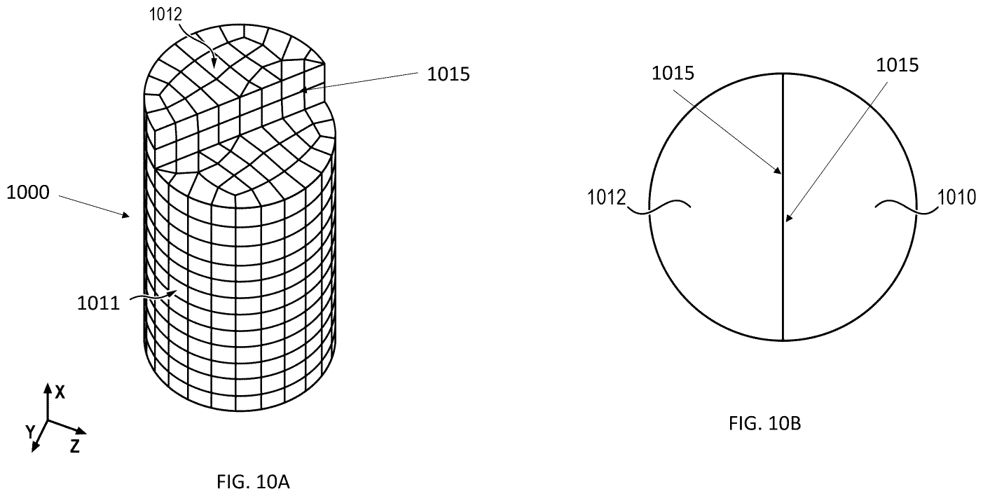

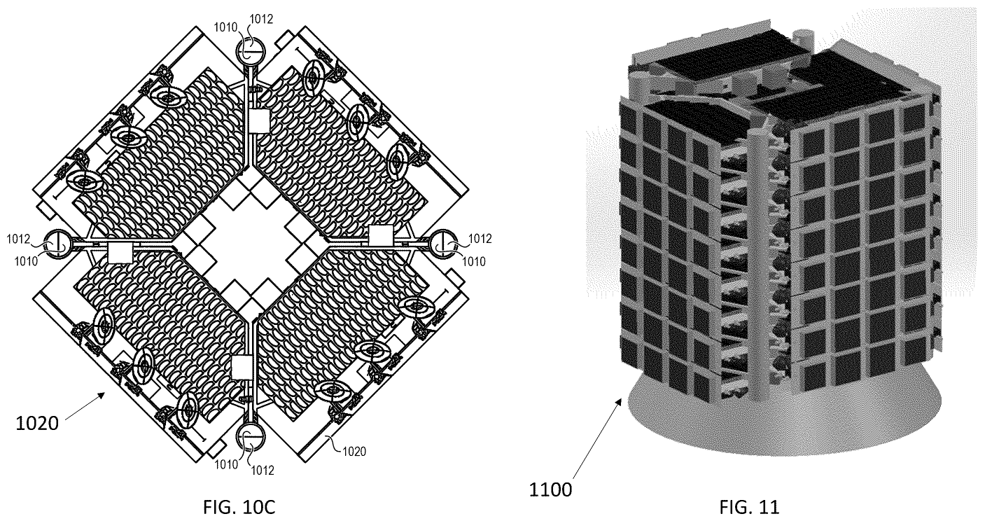

FIG. 10A shows a perspective view of another embodiment of a shear interface element 1000, in accordance with some embodiments of the invention. FIG. 10B shows an interface of two of the shear interface elements 1000, in accordance with some embodiments of the invention. The shear interface elements 1000 may include a body portion 1011, and a contacting portion 1012 that extends from the body portion 1011. As shown, the shear interface elements 1000 may include contact surfaces 1015 on the contacting portion 1012, in the form of complementary flat surfaces configured to contact one another. The shear interface elements 1000 may be shaped such that when the contact surfaces 1015 of the shear interface elements 1000 contact each other, the shear interface elements 1000 define a circular cross-section. By this arrangement, the shear interface elements 1000 abut one another in a manner so as to bear shear loads in the horizontal direction, as described with reference to the viewpoint of FIG. 10B, but not the vertical direction. However, it is understood that a layer including multiple pairs of the shear interface elements 1000 will have the shear interface elements 1000 at various orientations within a layer of the space vehicles 100, and thus the shear interface elements 1000 may be capable of bearing shear loads in multiple directions. FIG. 10C illustrates such a layer 1020 including multiple pairs of the shear interface elements 1000, in accordance with some embodiments of the invention.

As shown in FIGS. 8A and 8B, the layer 700 comprises the four space vehicles 100, designated as space vehicles 100a, 100b, 100c, and 100d. Each of the space vehicles comprises a top side 101; a bottom side 102 opposite the top side 101; a left side 103 between the top and bottom sides 101, 102; a right side 104 opposite the left side 103, and extending between the top and bottom sides 101, 102; a zenith facing side 105 extending between the top and bottom sides 101, 102; and an earth facing side 106 extending between the top and bottom sides 101, 102, and opposite the zenith facing side. The space vehicles include the shear interface elements, designated here as 900, which may be in accordance with the embodiments discussed above as interface elements 900 and/or 1000, 102, at left and right sides of the space vehicles. Thus, for example, the space vehicle 100a includes shear interface elements 900-1 at the left side, and shear interface element 900-2 at the right side; the space vehicle 100b includes shear interface elements 900-3 at the left side, and shear interface element 900-4 at the right side; the space vehicle 100c includes shear interface elements 900-5 at the left side, and shear interface element 900-6 at the right side; the space vehicle 100d includes shear interface elements 900-7 at the left side, and shear interface element 900-8 at the right side. As shown, the interface element 900-1 connects to the interface element 900-8; the interface element 900-2 connects to the interface element 900-3; the interface element 900-4 connects to the interface element 900-5, and the interface element 900-6 connects to the interface element 900-7, thereby to prevent the space vehicles from moving apart from one another, thereby forming the first layer of space vehicles. In some embodiments of the invention, the shear interface elements may be disposed within the pillars of the space vehicles. In some embodiments, the shear interface elements may be connected directly to the space vehicles, such as, for example, to the stiffeners of the space vehicles, and/or to other components and/or sides of the space vehicles.

In some embodiments, a curvature of the stiffener 300, to which the shear interface elements and/or the pillars connect, may be a radius of from (0.7*L) to (2*L), where L is a distance between the centers of two adjacent shear interface elements and/or pillars, wherein the radius is the radius of a circle through the centers of the shear interface elements and/or the pillars.

In some embodiments, due to the manner in which the stacking pillars 140, 142 interconnect different ones of the space vehicles 100, and particularly the stiffeners 300 thereof, within a launch stack, and in which shear loads are borne as described above, a launch stack including multiple layers of the space vehicles 100 performs mechanically as a single connected structure. FIG. 11 shows a stack 1100 including multiple ones of the space vehicles 100, and including multiple layer of the space vehicles, in accordance with some embodiments of the invention. As a result of the interconnected nature, the stack 1100 may act as a single connected structure that is stable and resistant to shear loads. In some embodiments, the stack 1100 is capable of reaching a minimum lateral frequency acceptable for launch. In some embodiments, the single connected structure comprised of the multiple ones of the space vehicles 100 may not require a central support structure. In some embodiments, a stiffness of the stack 1100 may be greater than a stiffness of the space vehicles 100 within the stack 1100. In some embodiments, a stiffness of the stack 1100 may be greater than a stiffness of any of the layers including the space vehicles 100 which form the stack 1100. In some embodiments, the system may provide a stack of satellites, including one, two, three, four, five, six, seven, eight, nine, ten, or more than ten layers of satellites or other space vehicles, where each layer includes one, two, three, four, five, six, seven, eight, nine, ten, or more than ten satellites or other space vehicles, as described.

In some embodiments, the space vehicles may include more than two pillars, and/or more than two shear interface elements. In some embodiments, the space vehicles may locate the pillars and/or shear interface elements in positions other than those shown in the figures. In some embodiments, the additional pillars may help supporting satellites during the stacking process. FIG. 12 shows an example of a space vehicle 100 including additional pillars 1200, which may be used for any or all of: retaining the space vehicle 100 within a layer; handling of the space vehicle 100 during placement of the space vehicle 100 within a layer; and/or handling of the space vehicle 100 and/or the stack in which the space vehicle 100 is placed during stacking of the layers.

While a number of embodiments of the present invention have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A system, comprising:
a first layer of satellites,
wherein the first layer of satellites comprises a first satellite, a second satellite, a third satellite, and a fourth satellite, and
wherein each of the first, second, third, and fourth satellites comprises:
a top side,
a bottom side opposite the top side,
a zenith facing side extending between the top and bottom sides,
wherein the zenith facing side is configured to face away from the earth when the satellite is in orbit,
an earth facing side opposite the zenith facing side and extending between the top and bottom sides,
wherein the earth facing side is configured to face the earth when the satellite is in orbit,
a left side extending between the top and bottom sides, and
a right side opposite the left side and extending between the top and bottom sides;
a first interface element connected to the first satellite, proximate the left side of the first satellite;
a second interface element connected to the first satellite, proximate the right side of the first satellite;
a third interface element connected to the second satellite, proximate the left side of the second satellite;
a fourth interface element connected to the second satellite, proximate the right side of the second satellite;
a fifth interface element connected to the third satellite, proximate the left side of the third satellite;
a sixth interface element connected to the third satellite, proximate the right side of the third satellite;
a seventh interface element connected to the fourth satellite, proximate the left side of the fourth satellite; and
an eighth interface element connected to the fourth satellite, proximate the right side of the fourth satellite,
wherein the first interface element connects to the eighth interface element,
wherein the second interface element connects to the third interface element,
wherein the fourth interface element connects to the fifth interface element, and
wherein the sixth interface element connects to the seventh interface element, to prevent the first, second, third, and fourth satellites from moving apart from one another, thereby forming the first layer of satellites.

2. The system of claim 1, further comprising:
a second layer of satellites,
wherein the second layer of satellites comprise a fifth satellite, a sixth satellite, a seventh satellite, and an eighth satellite,
wherein each of the fifth, sixth, seventh, and eighth satellites comprises:
a top side,
a bottom side opposite the top side,
a zenith facing side extending between the top and bottom sides,
an earth facing side opposite the zenith facing side and extending between the top and bottom sides,
a left side extending between the top and bottom sides, and
a right side opposite the left side and extending between the top and bottom sides;
a ninth interface element connected to the fifth satellite, proximate the left side of the fifth satellite;
a tenth interface element connected to the fifth satellite, proximate the right side of the fifth satellite;
an eleventh interface element connected to the sixth satellite, proximate the left side of the sixth satellite;
a twelfth interface element connected to the sixth satellite, proximate the right side of the sixth satellite;
a thirteenth interface element connected to the seventh satellite, proximate the left side of the seventh satellite;
a fourteenth interface element connected to the seventh satellite, proximate the right side of the seventh satellite;
a fifteenth interface element connected to the eighth satellite, proximate the left side of the eighth satellite; and
a sixteenth interface element connected to the eighth satellite, proximate the right side of the eighth satellite,
wherein the ninth interface element connects to the sixteenth interface element,
wherein the tenth interface element connects to the eleventh interface element,
wherein the twelfth interface element connects to the thirteenth interface element, and
wherein the fourteenth interface element connects to the fifteenth interface element,
to prevent the fifth, sixth, seventh, and eighth satellites from moving apart from one another, thereby forming the second layer of satellites.

3. The system of claim 1, wherein the second interface element comprises a second contact surface,
wherein the third interface element comprises a third contact surface, and
wherein the second and third contact surfaces are in contact with one another.

4. The system of claim 3, wherein the second interface element comprise a second body portion and a second contacting portion,
wherein the second contacting portion extends from the second body portion and comprises the second contact surface,
wherein the third interface element comprise a third body portion and a third contacting portion,
wherein the third contacting portion extends from the third body portion and comprises the third contact surface.

5. The system of claim 4, wherein each of the second and third contact surfaces comprises a flat surface.

6. The system of claim 4, wherein each of the second and third contact surfaces comprises a curved surface.

7. The system of claim 6, wherein each of the second and third contact surfaces comprises a surface having a convex portion and a concave portion.

8. The system of claim 1, wherein the first satellite further comprises a first pillar at the left side of the first satellite,
wherein the first interface element is at least partially within the first pillar, and wherein the first satellite further comprises a second pillar at the right side of the first satellite,
wherein the second interface element is at least partially within the second pillar.

9. The system of claim 8, wherein the first interface element comprise a first body portion within the first pillar, and a first contacting portion extending from the first body portion, and
wherein the second interface element comprise a second body portion within the second pillar, and a second contacting portion extending from the second body portion.

10. The system of claim 1, wherein the first satellite further comprises:
a stiffener,
wherein the stiffener extends between the left and right sides of the first satellite.

11. The system of claim 10, wherein the first and second interface elements are connected to the stiffener.

12. The system of claim 10, wherein the first satellite further comprises:
a first pillar at the left side of the first satellite,
wherein first interface element is at least partially within the first pillar; and
a second pillar at the right side of the first satellite,
wherein the second interface element is at least partially within the second pillar,
wherein the first and second pillars connect to the stiffener.

13. The system of claim 1, further comprising:
a second layer of satellites above the first layer of satellites,
wherein the second layer comprises four additional satellites.

14. The system of claim 1, further comprising:
seven additional layers of satellites above the first layer of satellites,
wherein each of the additional layers of satellites comprises four additional satellites.

15. A system, comprising:
a first layer of satellites,
wherein the first layer of satellites comprises a first satellite, a second satellite, a third satellite, a fourth satellite, a fifth satellite, and a sixth satellite, and
wherein each of the first, second, third, fourth, fifth, and sixth satellites comprises:
a top side,
a bottom side opposite the top side,
a zenith facing side extending between the top and bottom sides,
an earth facing side opposite the zenith facing side and extending between the top and bottom sides,
a left side extending between the top and bottom sides, and
a right side opposite the left side and extending between the top and bottom sides;
a first interface element connected to the first satellite, proximate the left side of the first satellite;
a second interface element connected to the first satellite, proximate the right side of the first satellite;
a third interface element connected to the second satellite, proximate the left side of the second satellite;
a fourth interface element connected to the second satellite, proximate the right side of the second satellite;
a fifth interface element connected to the third satellite, proximate the left side of the third satellite;
a sixth interface element connected to the third satellite, proximate the right side of the third satellite;
a seventh interface element connected to the fourth satellite, proximate the left side of the fourth satellite;
an eighth interface element connected to the fourth satellite, proximate the right side of the fourth satellite;
a ninth interface element connected to the fifth satellite, proximate the left side of the fifth satellite;
an tenth interface element connected to the fifth satellite, proximate the right side of the fifth satellite;
an eleventh interface element connected to the sixth satellite, proximate the left side of the sixth satellite; and
a twelfth interface element connected to the sixth satellite, proximate the right side of the sixth satellite;
wherein the first interface element connects to the twelfth interface element,
wherein the second interface element connects to the third interface element,
wherein the fourth interface element connects to the fifth interface element,
wherein the sixth interface element connects to the seventh interface element,
wherein the eighth interface element connects to the ninth interface element, and
wherein the tenth interface element connects to the eleventh interface element, to prevent the first, second, third, fourth, fifth, and sixth satellites from moving apart from one another, thereby forming the first layer of satellites.

16. The system of claim 15, wherein the second interface element comprises a second contact surface,
wherein the third interface element comprises a third contact surface, and
wherein the second and third contact surfaces are in contact with one another.

17. The system of claim 16, wherein the second interface element comprise a second body portion and a second contacting portion,
wherein the second contacting portion extends from the second body portion and comprises the second contact surface,
wherein the third interface element comprise a third body portion and a third contacting portion,
wherein the third contacting portion extends from the third body portion and comprises the third contact surface.

18. The system of claim 15, wherein the first satellite further comprises:
a stiffener,
wherein the stiffener extends between the left and right sides of the first satellite.

19. The system of claim 18, wherein the first and second interface elements are connected to the stiffener.

20. The system of claim 18, wherein the first satellite further comprises:
a first pillar at the left side of the first satellite,
wherein first interface element is at least partially within the first pillar; and
a second pillar at the right side of the first satellite,
wherein the second interface element is at least partially within the second pillar,
wherein the first and second pillars connect to the stiffener.
